(19) United States
(12) Patent Application Publication
(10) Pub. No.: US 2008/0055452 A1
(43) Pub. Date: Mar. 6, 2008

(54) Remote cinematography viewing device

(76) Inventor: Robert C. Carlson, Grayslake, IL (US)

Correspondence Address: McKenna McGovern Burkhart, 134 North LaSalle Street, Suite 2040, CHICAGO, IL, 60602, US

(21) Appl. No.: 11/511,641

(22) Filed: Aug. 29, 2006

(51) Int. Cl. H04N 5/222

(52) U.S. Cl. 348/333.01

(57) ABSTRACT

A remote video monitoring and control system for use in cinematography includes an ergonometrically balanced display device of sufficient size and resolution to display images useful in cinematography. A handgrip base is secured to the display device, and a power source is secured to the base. A video signal receiving mechanism is operatively connected to the display device, and receives video signals from a remote camera. A camera control arrangement is operatively connected to the display device to generate camera control signals from an operator of the camera control arrangement. A camera control signal transmitting mechanism transmits camera control signals from the camera control arrangement to the remote camera.

### CROSS-REFERENCE TO RELATED APPLICATIONS:

None

### STATEMENT AS TO RIGHTS TO INVENTIONS MADE UNDER FEDERALLY-SPONSORED RESEARCH AND DEVELOPMENT:

None

1. Field of the Invention

The invention relates generally to remote viewing devices, and specifically to arrangements for remote, real-time viewing and controlling of cinematography.

2. Description of Related Art

Video equipment has long been used in various ways in the cinematographic process. One common application is “video assist”, wherein a low-resolution (typically single-chip) video camera (color or b &w) is used to pick up an image in the view finding system of a movie camera. Video images captured by the camera are sent to a monitor, where they can be recorded for playback. Such images are seldom used for editing, but for monitoring aspects of the shot, such as framing. It is common for camera assistants to have a small onboard LCD monitor showing them the video tap image to assist in camera operation.

In some cinematography, images from a remote camera are fed to one or more monitors in a “video village”, where persons responsible for filming (for example, the director, assistant director, director of photography, assistant director, and/or camera assistants) can view real-time images while rehearsal or photography is being performed.

Handheld monitoring devices are known per se. Typically, handheld monitoring devices include a recording device, a display monitor, and a power source. In one known example, the monitoring device employs consumer-grade connectors and housing components. For example, to run a “VIDEO OUT”, delicate connectors such as Hiroshi 6 connectors are used. These connectors and housing components have proven to lack sufficient durability for use in cinematography applications, and are routinely destroyed by being dropped or knocked over.

Further, known devices have poor ergonomics, most notably small displays and awkward power source configurations. Display screens range from approximately 4 inches up to approximately 6.5 inches at maximum. These monitors are too small to display images useful in cinematography. Known devices typically include handles on opposite sides of the monitor, in a manner similar to handheld gaming devices. Power sources may include a battery in one of the handles, with an auxiliary battery pack mounted elsewhere. The combination of small display, awkward handles, and poor battery placement make known devices difficult to use and expensive to fabricate.

Remote video systems are known in several contexts, and are well represented in the patent literature. One example is U.S. Pat. No. 5,825,408 to Yuyama, which an imaging apparatus has a portable monitor. Image data taken by the imaging apparatus is compressed and stored. The monitor serves as a view finder which displays image data which is being observed, and also serves to reproduce and display image data stored in a memory. A removable modem is coupled to the imaging apparatus. When the modem is coupled to the imaging apparatus, image data obtained by photography is transmitted through the telephone line. Like the image data, voice data can be stored in the memory and transmitted through the modem. The image data and the voice data can be compressed and combined with each other. By transmitting and receiving such synthesized data, the imaging apparatus can be used as a TV telephone.

In another example, U.S. Pat. No. 5,760,848 to Cho is directed to a video monitor capable of being used as a portable video screen, in which an image is picked up by an image pick up device in response to an operating command signal, and the picked-up video signal is displayed on a display unit. The apparatus includes a portable television receiver for displaying a video signal supplied from the video camera through an apparatus body in monitor mode, and for receiving television broadcasts in a television signal reception mode wherein the display unit is detachable from the apparatus body. In addition, to use with a portable television receiver, the video monitor apparatus is adaptable for use with a video door-phone, a video camera, a video telephone or a rear monitor apparatus for an automobile.

U.S. Patent Publication No. US 2005/0110634 A1 to Salcedo shows a security system including a camera configured to generate a video signal, an object recognition system coupled to the camera and configured to receive and monitor the video signal and a portable digital assistant (PDA) wirelessly coupled to the object recognition system and the camera. The PDA may display video from the camera and/or data or alarms in response to output from the object recognition system. Methods of providing security information including displaying live video on a PDA and providing a signal on the PDA in response to output from the object recognition system are also provided.

In U.S. Patent Publication No. US 2005/0212920 A1 to Evans, a system for monitoring a plurality of video signals in an internal video network, such as a broadcast recording environment, or security camera network, is described. The system includes a picture monitor having a screen on which a mosaic video image containing the video signals from a plurality of cameras or other video devices is displayed. Selection of a video signal from the mosaic image can be performed to display a full screen version of that signal. Preferably, at the transmission stage of the network, only the mosaic video image is transmitted. By not transmitting the individual video signals separately, a large saving can be made on the band width required for the transmission as well as on the cost of the encoding components at the transmitter.

In another example, U.S. Patent Publication No. US 2005/0212918 A1 to Serra is directed to a monitoring system including a plurality of sensor elements for distribution at a location and a plurality of cameras for capturing video data of the location. The system further includes a display unit for displaying a graphical representation of a network of the sensor elements throughout the location and a video stream from any one of the cameras. The system further includes a navigation unit for navigating through the network of sensor elements displayed by the display unit, and a processing unit for selecting one of the cameras as the source of the video stream based on a current navigation position in the network of sensor elements.

In U.S. Patent Publication No. US 2005/0134454 A1 to Eskildsen, a security system is disclosed for a protected space such as a residential or commercial premises that transmits a wireless RF video transmission to a wireless RF portable video monitor/display accessible to a homeowner/person prior to the person entering the security system protected premises. The portable video monitor can be mounted on the dashboard of the person's automobile to display the status of the security system and possibly video images provided by the security system video cameras when the automobile is within range of the RF transmission, which can be a short range RF transmission, typically within visible range of the premises. This enables the person to review the status of the security system and video images before entering the premises to determine if it is safe to enter.

Finally, U.S. Patent Publication No. US 2006/0061664 A1 to Ito is directed to a camera control system consisting of a plurality of camera apparatus, camera control units coupled to the plural camera apparatus, respectively, a transmission path connected to the camera units and a base station connected to the transmission path. The base station has a database and the database is stored with setting values concerning at least photographing direction, image quality and voice quality of the plural camera apparatus and the plural camera control units in a plurality of table formats. An arbitrary camera control unit has a memory unit. A desired setting value of those stored in the database is downloaded to the memory unit on the basis of a command from the camera control unit and the setting values of the plural camera apparatus and the camera control units are modified with the downloaded setting value.

Although these known video systems provide some advantages, they present significant drawbacks as well. Many known remote video systems are intended for security systems and the like, and are unsuitable for cinematography. Other systems have poor ergonomics and lack durability.

It can be seen from the foregoing that the need exists for a durable, ergonometrically sound remote video monitoring and control system that is suitable for use in cinematography.

### SUMMARY

In accordance with the principles of the present invention, a remote video monitoring and control system for use in cinematography includes an ergonometrically balanced display device of sufficient size and resolution to display images useful in cinematography. A handgrip is secured to the display device, and a power source is secured to the base. A stand provides stability, and permits the system to be freestanding. A video signal receiving mechanism is operatively connected to the display device, and receives video signals from a remote camera. A camera control arrangement is operatively connected to the display device to generate camera control signals from an operator of the camera control arrangement. A camera control signal transmitting mechanism transmits camera control signals from the camera control arrangement to the remote camera.

The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 illustrates a schematic block diagram of a remote video monitoring and control system in accordance with the principles of the present invention.

FIG. 2 illustrates a schematic perspective view of a remote video monitoring and control system in accordance with the principles of the present invention.

FIG. 3 illustrates a detailed schematic perspective view of the FIG. 1 a remote video monitoring and control system with additional components.

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

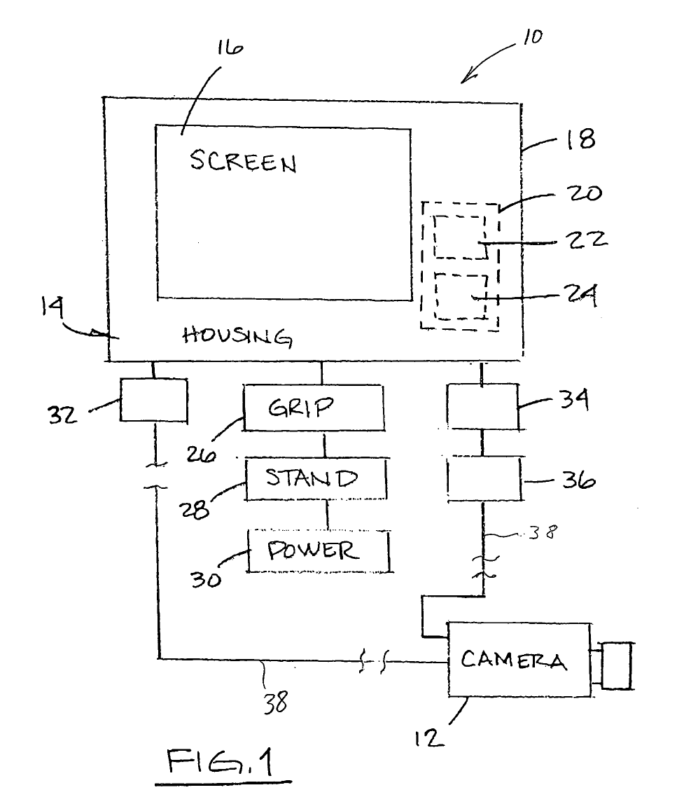

FIG. 1 illustrates a remote video monitoring and control system 10 in accordance with the principles of the present invention. The remote video monitoring and control system 10 is adapted and constructed for use in cinematography using a remote camera 12 capable of transmitting video signals and receiving control signals. The ergonometrically balanced system 10 includes a display device 14 capable of displaying video images from the remote camera 12. The display device 14 includes a display screen 16 of sufficient size and resolution to display images useful in cinematography. It is contemplated that cinematographic demands will dictate that the screen 16 will have a diagonal measurement of at least 7 inches. The display device 14 includes a housing 18 fabricated from a non-reflective, relatively rigid, durable material. One example of a suitable material is a polymer such as DELRIN®. The housing 18 can be provided with internal mounting space 20 to accommodate auxiliary components such as a recording device 22 and/or receiver 24.

A handgrip 26 is secured to the display device 12. The handgrip 26 is provided with a balanced configuration and weight that is ergonometrically designed to minimize fatigue for operators of the system 10. A stand arrangement 28 is secured to the ergonometrically balanced display device 14. The stand arrangement 28 is adapted and constructed to render the remote video monitoring and control system 10 freestanding on generally planar surfaces. The standard arrangement comprises a power source 30 secured to the stand, and provides sufficient power to operate the display device 14 and any other components of the system 10.

A video signal receiving mechanism 32 is operatively connected to the display device 14. The video signal receiving mechanism 32 is adapted and constructed to receive video signals from the remote camera 12. Signals can be received by the receiving mechanism 32 in any suitable manner. For example, the receiving mechanism 32 can be connected to the camera 12 via cables. Alternatively, the receiving mechanism 32 can be connected to the camera 12 wirelessly, as with a RF system 38.

A camera control arrangement 34 can be provided. The control arrangement 34 is secured to the display device 14, and is adapted and constructed to generate camera control signals from an operator of the camera control arrangement. The control arrangement 34 is preferably used to control any desired aspects of camera operation, such as camera iris, aperture, zoom, and camera angle. The control arrangement can include a manual controller such as a thumb controller, joystick, mouse, or touchscreen incorporated into the screen 16. A camera control signal transmitting mechanism 36 is operatively associated with the camera control arrangement 34. The camera control signal transmitting mechanism 36 is adapted and constructed to transmit camera control signals from the camera control arrangement 34 to the remote camera 12. Signals can be transmitted by the transmitting mechanism 36 in any suitable manner. For example, the transmitting mechanism 36 can be connected to the camera 12 via cables. Alternatively, the transmitting mechanism 36 can be connected to the camera 12 wirelessly, as with a RF 38 system, which should include a RF antenna booster. In another example, the transmitting mechanism 36 can be provided with wireless communications technology, such as BLUETOOTH®, which allows audio or other direct communications between the operator of the device 10 and remotely-located cinematographic personnel. Moreover, multiple remote operators of the devices 10 can use the transmitting mechanism to communicate between themselves.

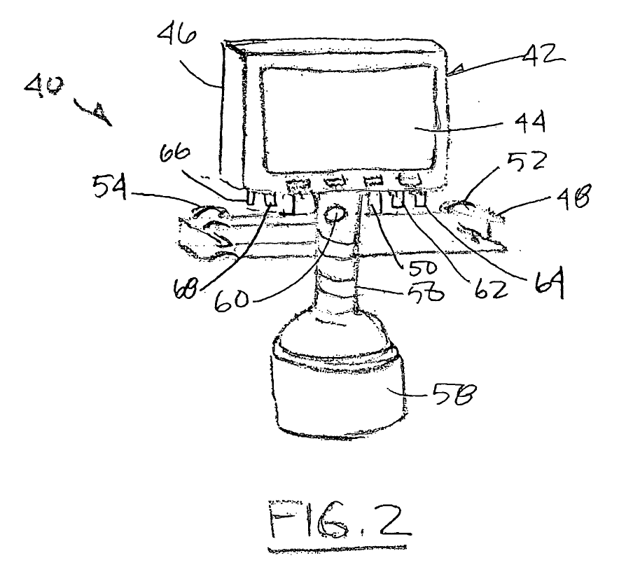

FIG. 2 illustrates an embodiment of a remote video monitoring and control system 40 in accordance with the principles of the present invention. The remote video monitoring and control system 40 is adapted and constructed for use in cinematography using a remote camera, as in FIG. 1. The system 40 includes an ergonometrically balanced display device 42 capable of displaying video images from the remote camera. The display device 14 includes a display screen 44 in a housing 46. As set forth supra, the housing 46 can be fabricated from DELRIN®, and provided with chamfered or rounded edges. A bracket 48 is secured to the display device 42 via a plate 50, and is provided with component mounting fasteners 52, 54. The mounting fasteners 52, 54 are shown as threaded studs extending from knurled, rotatable knobs, as is known in the art.

A hand grip 56 is secured to the plate 50, and extends generally downwardly from the display 42. The grip 56 is shown as having a girth and angular disposition similar to grips used in power hand tools, the egonometric soundness of which have been proven through long use. It has been found that a hand grip configured similarly to those used in conjunction with DEWALT® power tools provides particular advantage.

A power source 58 operated by a power switch 60 is formed integrally with the grip 56. The power source 60 can be similar to those used in DEWALT® 14.4 volt power tool systems, using Nicad or Nickel Metal Hydride technology. It is also contemplated that lithium ion batteries could be used. The power source 58 has a generally flat bottom and relatively high mass. These attributes enable its use as a stand arrangement for the system 40.

The system 40 is provided with video out/control connection 62, 64, which can be provided, for example, as BNC video out connections. Video signal receiving connections 66, 68 are also in place on the housing 46, and can be provided, for example, as connectors associated with a NTSC/PAL receiver.

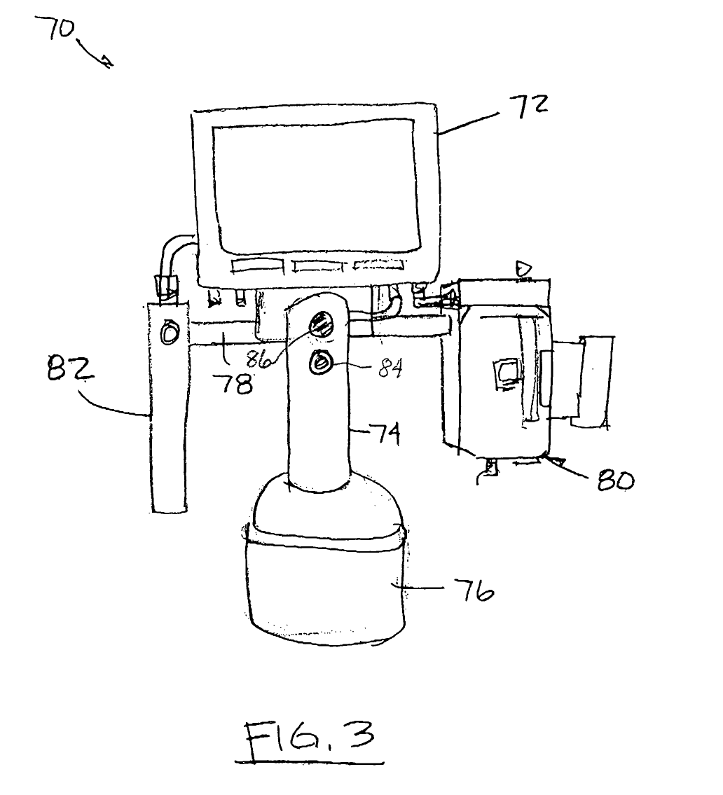

FIG. 3 illustrates another embodiment of a remote video monitoring and control system 70 in accordance with the principles of the present invention. The system 70 includes a display 72, grip 74, stand/power supply 76, and bracket 78 as described previously. Mounted on the bracket 78 is a camera controller 80, here provided as a PRESTON CINEMA SYSTEMS FI+Z. The controller 78 includes a zoom controller 82 mounted on the bracket 78, and a remote iris controller 84 secured in the grip 74. Also secured to the grip 74 is an on/off switch 86. The controller 80 as shown is configured for wireless operation, and is provided with a RF antenna booster as described previously.

It can be seen from the foregoing that the present invention provides advantages in a wide range of applications. While details of the invention are discussed herein with reference to some specific examples to which the principles of the present invention can be applied, the applicability of the invention to other devices and equivalent components thereof will become readily apparent to those of skill in the art. Accordingly, it is intended that all such alternatives, modifications, permutations, and variations to the exemplary embodiments can be made without departing from the scope and spirit of the present invention.

What is claimed is:

1. A remote video monitoring and control system for use in cinematography using a remote camera capable of transmitting video signals and receiving control signals, the system comprising the following:
A. an ergonometrically balanced display device capable of displaying video images from the remote camera, the display device being of sufficient size and resolution to display images useful in cinematography;
B. a handgrip secured to the display device;
C. a stand arrangement secured to the ergonometrically balanced display device, the stand arrangement being adapted and constructed to render the remote video monitoring and control system freestanding on generally planar surfaces;
D. a power source secured to the base;
E. a video signal receiving mechanism operatively connected to the display device, said video signal receiving mechanism being adapted and constructed to receive video signals from the remote camera;
F. a camera control arrangement secured to the display device, the camera control arrangement being adapted and constructed to generate camera control signals from an operator of the camera control arrangement, said control signals being selected from a group consisting essentially of camera aperture and zoom; and
G. a camera control signal transmitting mechanism operatively associated with the camera control arrangement, the camera control signal transmitting mechanism being adapted and constructed to transmit camera control signals from the camera control arrangement to the remote camera.

2. A remote video monitoring and control system in accordance with claim 1, wherein the camera control signal transmitting mechanism comprises a RF antenna booster.

3. A remote video monitoring and control system in accordance with claim 2, wherein the camera control signal transmitting mechanism comprises a BNC video out connection.

4. A remote video monitoring and control system in accordance with claim 1, wherein the ergonometrically balanced display device comprises a polymer housing.

5. A remote video monitoring and control system in accordance with claim 4, wherein the polymer housing comprises mounting space for auxiliary components.

6. A remote video monitoring and control system in accordance with claim 5, further comprising a recording device disposed in the mounting space of the housing.

7. A remote video monitoring and control system in accordance with claim 1, wherein the camera control arrangement is adapted and constructed to generate signals to control operational aspects of the remote camera selected form a group consisting essentially of zoom, iris, focus, and angular positioning.

8. A remote video monitoring and control system in accordance with claim 1, wherein the camera control arrangement comprises a manual input device.

9. A remote video monitoring and control system in accordance with claim 8, wherein the manual input device comprises a thumb controller.

10. A remote video monitoring and control system in accordance with claim 8, wherein the manual input device comprises a joystick.

12. A remote video monitoring and control system in accordance with claim 8, wherein the manual input device comprises a touchscreen incorporated into the display device.

13. A remote video monitoring and control system in accordance with claim 8, wherein the manual input device comprises a mouse.

14. A remote video monitoring and control system in accordance with claim 1, wherein the ergonometrically balanced display device comprises a display screen having a diagonal dimension of 7 inches or greater.

15. A remote video monitoring and control system in accordance with claim 1, wherein the video signal receiving mechanism comprises a NTSC/PAL receiver.

16. A remote video monitoring and control system in accordance with claim 1, wherein the camera control arrangement comprises a Preston rig.

17. A remote video monitoring and control system in accordance with claim 1, wherein the camera control signal transmitting mechanism comprises a wireless audio communication mechanism.

18. A remote video monitoring and control system for use in cinematography, the system comprising the following:
A. an ergonometrically balanced display device of sufficient size and resolution to display images useful in cinematography;
B. a handgrip secured to the display device;
C. a stand arrangement secured to the ergonometrically balanced display device, the stand arrangement being adapted and constructed to render the remote video monitoring and control system freestanding on generally planar surfaces;
D. a power source connected to the display device; and
E. a camera control arrangement operatively connected to the power source;
Whereby an operator of the remote video monitoring and control system uses the camera control mechanism to change operational aspects of the remote camera based on images received from the remote camera and displayed on the display device.

19. A remote video monitoring and control system in accordance with claim 18, further comprising a recording device operatively connected to the display.

20. A remote video monitoring and control system in accordance with claim 18 wherein the handgrip is positioned with respect to the stand so as to minimize operator fatigue.

21. A remote video monitoring and control system in accordance with claim 18, wherein the handgrip and stand form an integral unit.
